(19) United States
(12) Patent Application Publication
(10) Pub. No.: US 2022/0283309 A1
(43) Pub. Date: Sep. 8, 2022

(54) GROUND HEIGHT MEASUREMENT METHOD, GROUND HEIGHT MEASURING DEVICE, AND PROGRAM

(71) Applicant: NIPPON TELEGRAPH AND TELEPHONE CORPORATION, Tokyo (JP)

(72) Inventors: Yukihiro GOTO, Musashino-shi, Tokyo (JP); Ryuji HONDA, Musashino-shi, Tokyo (JP); Masaki WAKI, Musashino-shi, Tokyo (JP); Takashi GOTO, Musashino-shi, Tokyo (JP)

(73) Assignee: NIPPON TELEGRAPH AND TELEPHONE CORPORATION, Tokyo (JP)

(21) Appl. No.: 17/636,609

(22) PCT Filed: Aug. 23, 2019
(86) PCT No.: PCT/JP2019/033140

§ 371 Date: Feb. 18, 2022

(51) Int. Cl. G01S 17/89; G01B 11/06; G01S 19/49

(52) U.S. Cl. CPC G01S 17/89; G01B 11/0608; G01S 19/49

(57) ABSTRACT

An object of the present disclosure is to provide a ground-based height measurement method, a ground-based height measurement device, and a program capable of measuring the lowest height of a cable above a ground even when three-dimensional point cloud data of the cable is insufficient. The ground-based height measurement method according to the present disclosure can acquire three-dimensional point cloud data that seems to be a cable by forming a measurement range of a predetermined size above a travel trajectory of MMS (at an arrangement height of the cable). Then, the number of three-dimensional point clouds included in the measurement range is counted and when the number is equal to or larger than a threshold value, the height is measured as a measurement object. The ground-based height measurement method according to the present disclosure can measure the lowest height of the cable above a ground even when the three-dimensional point cloud data of the cable is insufficient because modeling is not performed from the three-dimensional point cloud data.

### TECHNICAL FIELD

The present disclosure relates to a ground-based height measurement method, a ground-based height measurement device, and a program for measuring a height of cables arranged around roads.

### BACKGROUND ART

A communication or electrical cable is required to be installed at a height of at least a certain height from a ground. The cable is checked using ground-based height measurement for the presence or absence of sagging and the like. The known ground-based height measurement method includes, for example,

(1) a method of measuring a length by extending a measure on a rod called a “measuring rod” from the ground to a cable as illustrated in FIG. 1,
(2) a method of using a vehicle equipped with a distance sensor as illustrated in FIG. 2 (for example, see PTL 1),
(3) a method of modeling a cable from point cloud data acquired by a vehicle or the like equipped with a laser scanner called mobile mapping system (MMS) and measuring a ground-based height from model information as illustrated in FIG. 3 (for example, see PTL 2).

### CITATION LIST

### Patent Literature

PTL 1: JP 2009-103536 A
PTL 2: JP 2018-195240 A

### SUMMARY OF THE INVENTION

### Technical Problem

As for the method (1), a person needs to run the risk of standing on a road in order to actually extend the measuring rod on the road or the like and the working time is extremely long, such as having to occupy the road for measurement. The problems of the method (1) are solved by the method (2).

The method (2) enables the measurement time to be shorten or the risk to be reduced because the distance sensor using radio waves is mounted on the upper portion of the vehicle and the height of the cable existing right above the vehicle is estimated while the vehicle is running. However, as for the method (2), the lowest ground-based height is not easily and correctly measured if the lowest point of the cable does not exist right above the vehicle. The problem of the method (2) is solved by the method (3).

The method (3) acquires three-dimensional point cloud data by running the vehicle equipped with a system called a mobile mapping system (MMS) and including an image and a laser, and infers and models the cable from the acquired three-dimensional point cloud data. This method enables the ground-based height to be measured from the model information even when the cable does not exist right above the vehicle. However, as for the method (3), when the three-dimensional point cloud data of the cable to be measured is insufficient, modeling cannot be performed. As a result, the lowest ground-based height is not easily measured.

Here, in order to solve the problem of the method (3), an object of the present disclosure is to provide a ground-based height measurement method, a ground-based height measurement device, and a program capable of measuring the lowest height of a cable above the ground even when three-dimensional point cloud data of the cable is insufficient.

### Means for Solving the Problem

In order to achieve the above-described object, a ground-based height measurement method according to the present disclosure measures a ground-based height by assuming a three-dimensional point cloud the number of which exceeds a predetermined threshold value at a predetermined height as a cable without performing modeling from three-dimensional point cloud data.

Specifically, the ground-based height measurement method according to the present disclosure includes: acquiring a travel trajectory of a vehicle equipped with a mobile mapping system (MMS); forming a measurement range located at a relative position set in advance with respect to the travel trajectory; counting the number of three-dimensional point cloud data included in the measurement range and measured by the MMS, and calculating a ground-based height of an object of the three-dimensional point cloud data from the three-dimensional point cloud data when the number of three-dimensional point cloud data is equal to or smaller than a threshold value.

Further, a ground-based height measurement device according to the present disclosure includes: a trajectory acquiring unit configured to acquire a travel trajectory of a vehicle equipped with a mobile mapping system (MMS); a measurement range forming unit configured to form a measurement range located at a relative position set in advance with respect to the travel trajectory; a count unit configured to count the number of three-dimensional point cloud data included in the measurement range and measured by the MMS; and a calculation unit configured to calculate a ground-based height of an object of the three-dimensional point cloud data from the three-dimensional point cloud data when the number of three-dimensional point cloud data is equal to or smaller than a threshold value.

The ground-based height measurement method or device according to the present disclosure can acquire three-dimensional point cloud data that seems to be a cable by forming a measurement range of a predetermined size above the travel trajectory of the MMS (at an arrangement height of the cable). Then, the number of three-dimensional point clouds included in the measurement range is counted and when the number is equal to or smaller than a threshold value, the height is measured as a measurement object. The ground-based height measurement method or device according to the present disclosure can measure the lowest height of the cable above the ground even when the three-dimensional point cloud data of the cable is insufficient because modeling is not performed from the three-dimensional point cloud data.

The ground-based height may be calculated using coordinates of a point having the lowest altitude in the three-dimensional point cloud data and the ground-based height may be calculated using an average value of altitudes of all points of the three-dimensional point cloud data.

Further, in order not to acquire three-dimensional point cloud data of a structure other than the cable, the measurement range may have a rectangular parallelepiped shape and be located above the travel trajectory, or the measurement range may have a pyramid or cone shape having a higher altitude as a bottom surface and be located above the travel trajectory depending on a situation.

In order not to erroneously detect the tree or the like, it is preferable that the threshold value be 500 to 1000.

The present disclosure is a program for causing a computer to perform the ground-based height measurement method. The device of the present disclosure can be also provided by a computer and a program and the program can be recorded on a recording medium or provided via a network.

Note that each of the inventions described above can be combined with each other to the extent possible.

### Effects of the Invention

The present disclosure can provide a ground-based height measurement method, a ground-based height measurement device, and a program capable of measuring the lowest height of a cable above the ground even when three-dimensional point cloud data of the cable is insufficient.

### BRIEF DESCRIPTION OF DRAWINGS

FIG. 1 is a diagram illustrating a ground-based height measurement method for a cable.

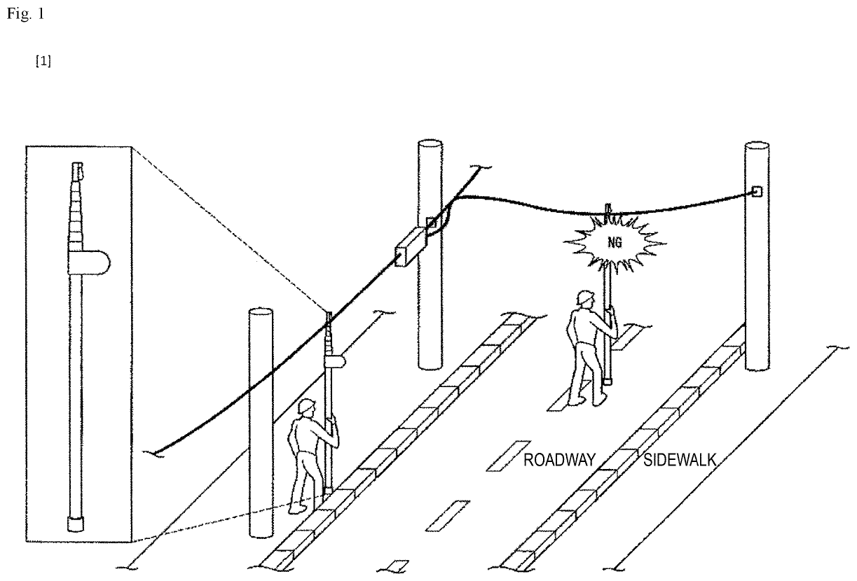

FIG. 2 is a diagram illustrating the ground-based height measurement method for a cable.

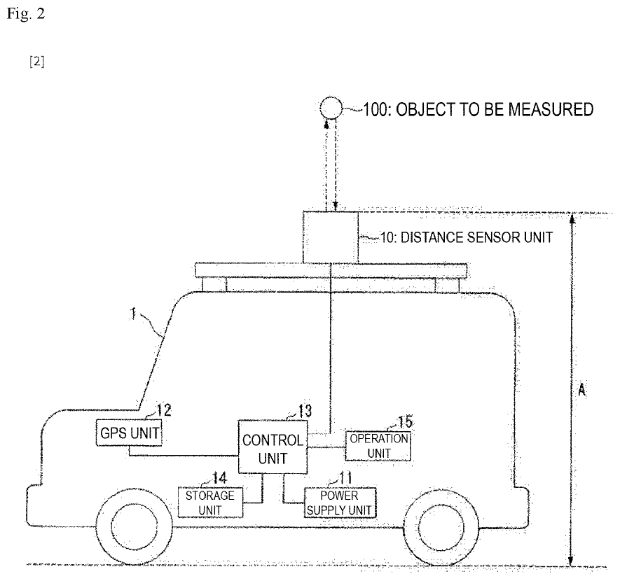

FIG. 3 is a diagram illustrating the ground-based height measurement method for a cable.

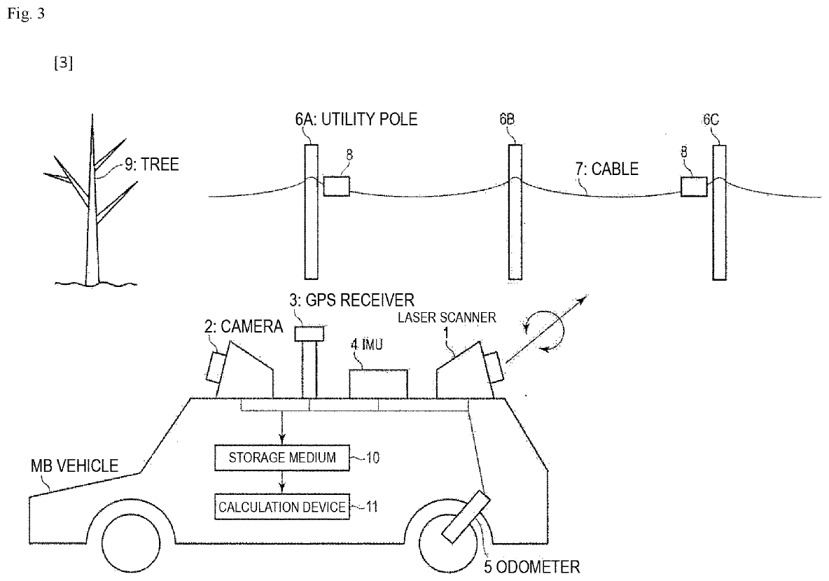

FIG. 4 is a diagram illustrating a ground-based height measurement device according to the present disclosure.

FIG. 5 is a diagram illustrating a measurement range of the ground-based height measurement device according to the present disclosure.

FIG. 6 is a flowchart illustrating a ground-based height measurement method according to the present disclosure.

FIG. 7 is a diagram illustrating the ground-based height measurement method according to the present disclosure.

FIG. 8 is a diagram illustrating the ground-based height measurement method according to the present disclosure.

FIG. 9 is a diagram illustrating the influence of a threshold value to be set in the ground-based height measurement method according to the present disclosure.

FIG. 10 is a diagram illustrating a measurement result of the ground-based height measurement device according to the present disclosure.

FIG. 11 is a diagram illustrating a measurement result of the ground-based height measurement device according to the present disclosure.

FIG. 12 is a diagram illustrating a measurement result of the ground-based height measurement device according to the present disclosure.

FIG. 13 is a diagram illustrating the ground-based height measurement device according to the present disclosure.

FIG. 14 is a diagram illustrating the ground-based height measurement device according to the present disclosure.

### DESCRIPTION OF EMBODIMENTS

Embodiments of the present disclosure will be described with reference to the accompanying drawings. Embodiments to be described below are examples of the present disclosure and the present disclosure is not limited to the embodiments below. Note that the components indicated by the same reference numerals in the present specification and the drawings are the same components.

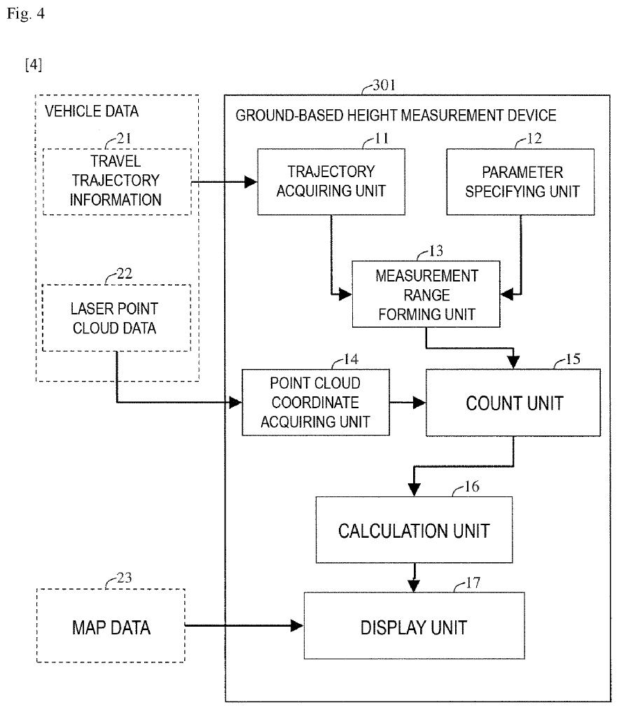

FIG. 4 is a diagram illustrating a ground-based height measurement device 301 according to this embodiment. The ground-based height measurement device 301 includes a trajectory acquiring unit 11 configured to acquire a travel trajectory 50 of a vehicle equipped with a mobile mapping system (MMS); a measurement range forming unit 13 configured to form a measurement range 60 located at a relative position set in advance with respect to the travel trajectory 50; a count unit 15 configured to count the number of three-dimensional point cloud data 31 included in the measurement range 60 and measured by the MMS; and a calculation unit 16 configured to calculate a ground-based height of an object of the three-dimensional point cloud data from the three-dimensional point cloud data 31 when the number of three-dimensional point cloud data 31 is equal to or smaller than a threshold value.

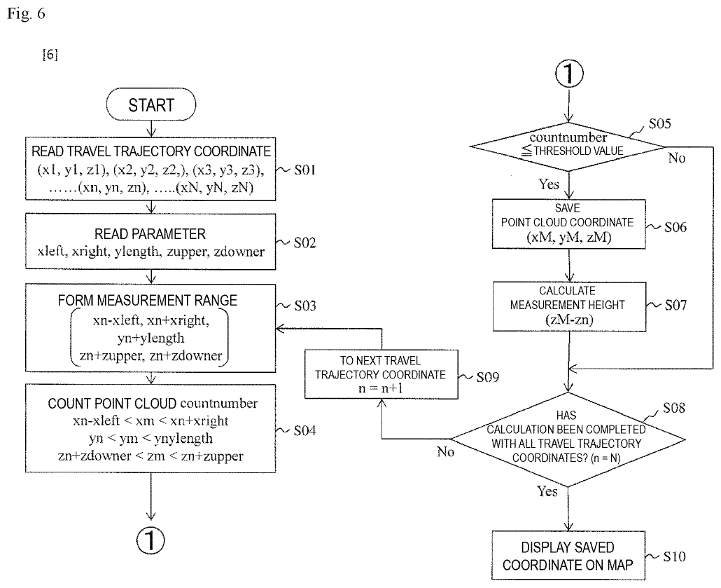

FIG. 6 is a flowchart illustrating operations of the ground-based height measurement device 301.

The trajectory acquiring unit 11 acquires travel trajectory coordinates from travel trajectory information 21 acquired by the MMS vehicle (step S01). A parameter specifying unit 12 specifies a relative distance from the travel trajectory 50, a left width xleft, a right width xright, a bottom height zdowner, a top height zupper, a breadth of depth ylength, and a measurement interval Δ as parameters (step S02). These values are set in advance.

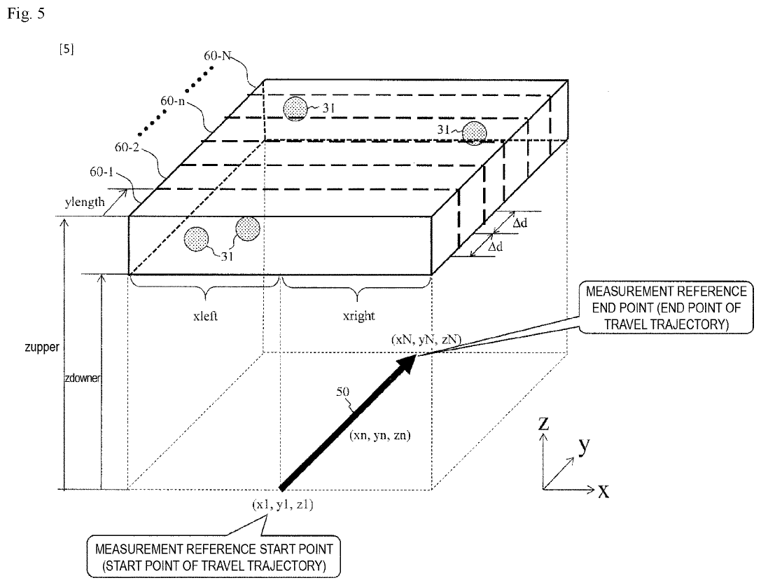

The measurement range forming unit 13 forms the measurement range 60 above the travel trajectory 50 using the above-described parameters (step S03). FIG. 5 is a diagram illustrating the measurement range 60 formed by the measurement range forming unit 13. A plurality of measurement ranges 60 are formed along the travel trajectory 50 (measurement ranges 60-1 to 60-N; N is a natural number of two or more). In FIG. 5, the measurement range 60 is described as a rectangular parallelepiped shape for ease of description, but the measurement range 60 can take on any shape. As will be described later, the shape of the measurement range 60 may be in the form of inverted square pyramids or the like in order not to erroneously detect obstructions such as fences. Further, in FIG. 5, the breadth of depth ylength and the measurement interval Δ are the same value, but both of them may be set to different values.

The point cloud coordinate acquiring unit 14 acquires point cloud coordinates from laser point cloud data 22 acquired by the MMS vehicle. The measurement unit 15 counts the number of point clouds included in each measurement range 60-n (n is a natural number up to N) (step S04). Then, the measurement unit 15 compares the counted number of point clouds with a threshold value (step S05). When the number of point clouds is equal to or smaller than the threshold value, the measurement unit 15 determines that a cable has been detected and saves a coordinate (xM, yM, zM) about the relevant point clouds (step S06). Note that the detected object is not necessarily the cable because it is determined only by the number of point clouds. On the other hand, the measurement unit 15 determines that the point cloud is not the cable when the number of point clouds is equal to or larger than the threshold value (“No” in step S05). Note that the detected object is not necessarily the cable because the measurement unit 15 determines only by the number of point clouds. Objects other than the cable may be erroneously detected. The frequency of erroneous detection varies with the set threshold value. The setting of the threshold value will be described below.

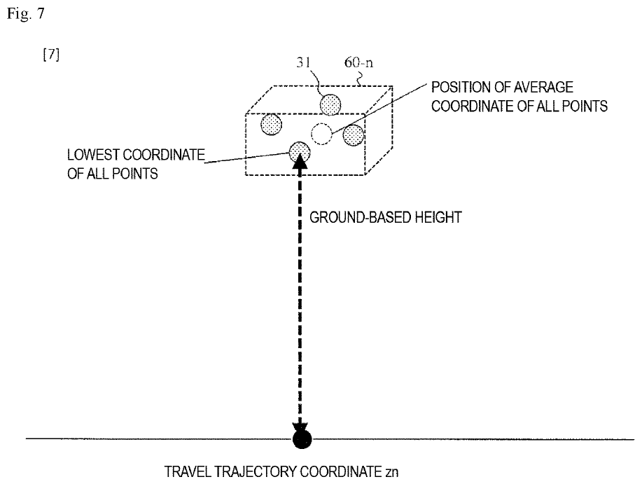

Here, the coordinate (xM, yM, zM) may be the coordinate of the point having the lowest altitude (minimum z) in the point clouds included in the measurement range 60-n in which the cable is detected, may be the coordinate of the center value for all of the point clouds, or may be the average coordinate for all of the point clouds (see FIG. 7).

The calculation unit 16 calculates a difference between the point cloud coordinates zM and the travel trajectory coordinates zn as the ground-based height using the detected point cloud coordinates (xM, yM, zM) and the travel trajectory coordinates (step S07). Here, when the calculation is not completed in all the travel trajectory coordinates (n≠N) (“No” in step S08), step S03 to step S08 are repeated at the next travel trajectory coordinate n+1 (step S09). When the calculation is completed in all the travel trajectory coordinates (“Yes” in step S08), the display unit 17 displays the detected point cloud coordinates (xM, yM, zM) on map data together with the travel trajectory coordinates (xn, yn, zn) (step S10).

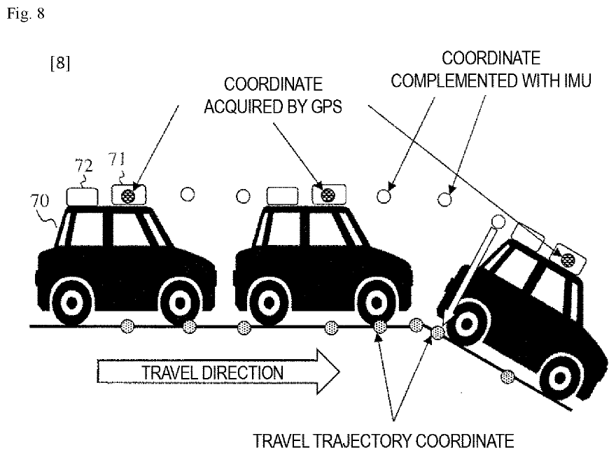

FIG. 8 is a diagram illustrating a method of acquiring the travel trajectory information 21. A vehicle 70 equipped with MMS includes a GPS 71 and an IMU 72. The GPS 71 periodically acquires positional information ((x, y, z)=(latitude, longitude, altitude) as the vehicle 70 moves. Hereinafter, this information is referred to as “GPS information”). The IMU 72 acquires acceleration data (pitch, roll, yaw) of the vehicle 70. When the time interval becomes too long at single use of the GPS information, the acceleration data of the IMU 72 is used to complement the GPS information. The travel trajectory information 21 is a coordinate obtained by subtracting the height (the installed height of the GPS 71) of the vehicle 70 from the information complemented with the GPS information.

### GPS: Global Positioning System

### IMU: Inertial Measurement Unit

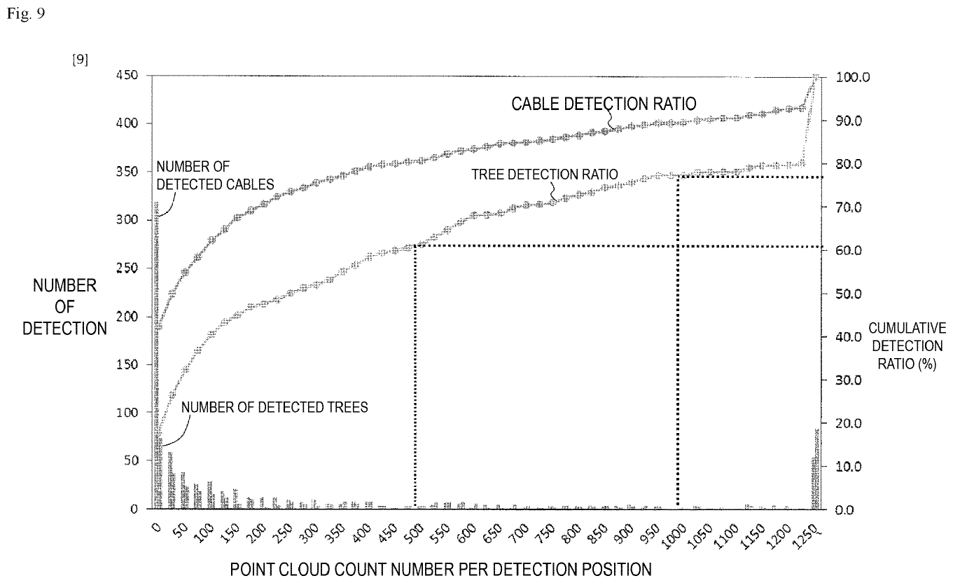

The threshold value of step S06 of FIG. 6 is preferably 500 to 1000. FIG. 9 illustrates a variation in erroneous detection due to the setting of the threshold value. FIG. 9 is a graph in which a horizontal axis, a first vertical axis, and a second vertical axis are as below.

Horizontal axis: the number of points included in position detected as one point cloud (point cloud count number)
First vertical axis: an axis of the bar graph and the number of cases (number of detections) in which detection position is cable or tree for each point cloud count number.
For example, the two leftmost bars of the bar graph indicate the detection positions in which the point cloud count number is 1 to 25, where 315 were cables and 75 were trees.
Second vertical axis: an axis of the line graph and ratio (cumulative detection ratio) between cumulative number of detections for each point cloud count number in ascending order of point cloud count number and total number of detections of all point cloud count numbers for each type of detection position (cable or tree).
For example, 83% which is the value of 500 point cloud counts on the line graph of the cable indicates the ratio between the total number of positions each of which is detected as a cable among the positions detected in the point cloud counts 1 to 500 (the total number of detected cables with a point cloud count up to 500) and the total number of positions each of which is detected as a cable in all point clouds regardless of the point cloud count number. That is, when the point cloud count number is 500 or less, 83% of all cables can be detected.

As indicated by the line graph of FIG. 9, as the point cloud count number increases, the cable detection rate (cumulative detection ratio) increases. However, at the same time, the tree detection rate (cumulative detection ratio) also increases and the frequency of erroneous detection increases. Here, as illustrated in the line graph of FIG. 9, it can be seen that the number of point clouds for detecting a cable becomes smaller than the number of point clouds for detecting a tree as long as the detection rate is the same. Therefore, for example, when the point cloud count number is 1000 or less, the cable detection rate is 90% and the tree detection rate is 77%. Then, when the point cloud count number is 500 or less, the cable detection rate is 80% and the tree detection rate is 60%. And thus, the erroneous detection ratio can be reduced. That is, when the threshold value of step S05 in FIG. 6 is set to 500 to 1000, the tree detection rate (erroneous detection ratio) can be preferably reduced while maintaining a high cable detection rate.

### Example 1

This example illustrates a measurement result obtained by the ground-based height measurement device 301 according to this embodiment while a vehicle travels in a general residential area (residential areas No. 1 and No. 2).

Each parameter specified by the parameter specifying unit 12 is as below.
Left width xleft=1.2 m
Right width xright=1.2 m
Bottom height zdowner=4.5 m
Top height zupper=6.5 m
Breadth of depth ylength=2.0 m
Measurement interval Δ=0.1 seconds
Threshold value=1000
Further, the vehicle travel distance (measurement distance) is about 4 km and the vehicle speed (measurement speed) is 20 km/h on average.

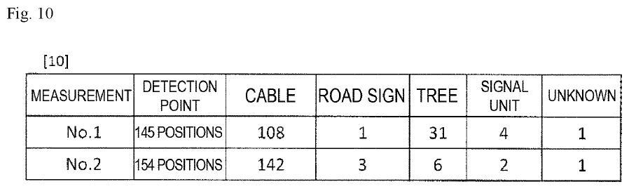

FIG. 10 is a table showing the number of positions each of which is detected as a point cloud by the ground-based height measurement device 301 and the breakdown thereof Δn object other than the cable is an erroneous detection. Measurements No. 1 and No. 2 illustrate the results of different residential areas. The result of FIG. 10 shows that the ground-based height measurement device 301 can accurately detect the cable in both residential areas. The ground-based height measurement device 301 also performed erroneous detection, but most of them were roadside trees planted on the side of the road. These can be easily inferred by looking at the photographic display.

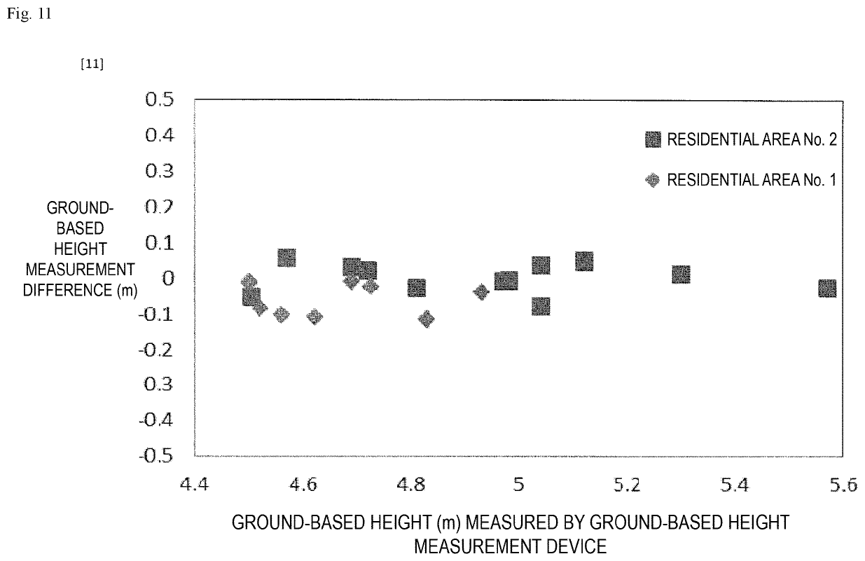

FIG. 11 is a diagram illustrating the measurement accuracy of the ground-based height measurement device 301. In the graph of FIG. 11, the horizontal axis indicates the height (measurement value) of the cable detected by the ground-based height measurement device 301 and the vertical axis indicates the difference between the measurement value and the height (true value) measured at the same position using the measuring rod. The diamond and square plots are cable data in the residential area No. 1 and residential area No. 2. FIG. 11 shows that the ground-based height measurement device 301 can measure the ground-based height with almost the same accuracy (with errors within 0.1 m) as compared with the measuring rod.

### Example 2

This example illustrates a measurement result obtained by the ground-based height measurement device 301 according to this embodiment while a vehicle travels in a general residential area (residential area No. 3). This example illustrates the difference in the detection result when the measurement range is changed.

Each parameter specified by the parameter specifying unit 12 is as below.
Left width xleft=0.2 m
Right width xright=2.2 m
Bottom height zdowner=4.5 m
Top height zupper=6.5 m
Breadth of depth ylength=2.0 m
Measurement interval Δ=0.1 seconds
Threshold value=1000
Further, the vehicle travel distance (measurement distance) is about 4 km and the vehicle speed (measurement speed) is 20 km/h on average. The parameters of the comparative example are as in Example 1. That is, the measurement range of this example is set to the right of the vehicle as compared with the measurement range of the comparative example.

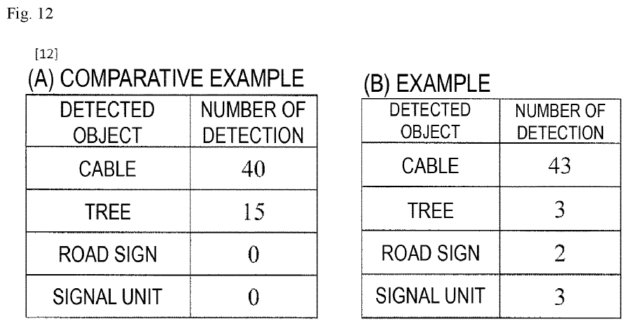

FIG. 12 is a diagram illustrating the result when the measurement range is changed as described above. FIG. 12(A) illustrates the comparative example. FIG. 12(B) illustrates the example in which the measurement range is set to the right.

In the measurement range of the comparative example, the trees were detected at 15 positions. On the other hand, in the measurement range of this example, it was possible to avoid detecting trees existing on the shoulder of the road and to greatly reduce the detection of trees to 3 positions. On the other hand, in the measurement range of this example, the number of detection positions of the road sign or the signal unit increases. For this reason, the measurement range is preferably set as in this example at the measurement position in which trees exist on the shoulder of the road and the measurement range is preferably set as in Example 1 at the measurement position in which trees do not exist on the shoulder of the road.

### Example 3

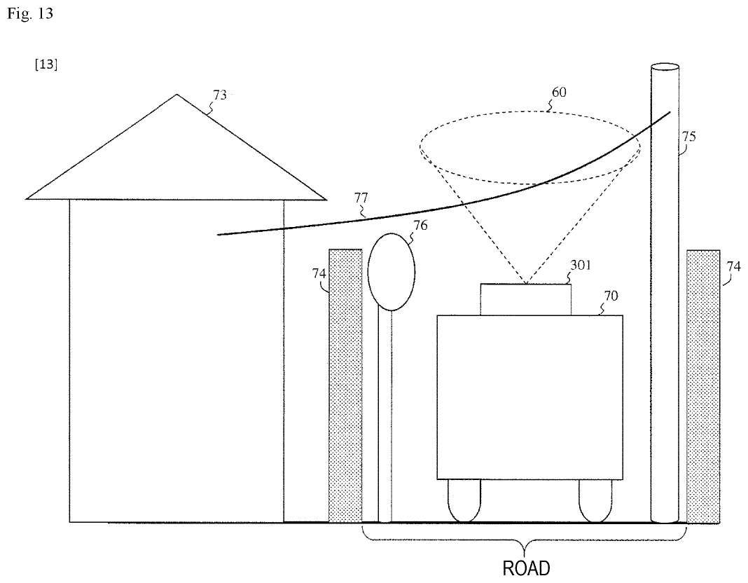

The shape of the measurement range is not limited to the rectangular parallelepiped shape described in FIG. 5 or 7. For example, when the shape of the measurement range is set to the rectangular parallelepiped shape in the narrow road, it is likely to erroneously detect a house 73, a fence 74, a utility pole 75, a road sign 76, and other structures. For that reason, when the measurement range 60 is set to an inverted square pyramid shape or an inverted cone shape as in FIG. 13, the ground-based height measurement device 301 can perform measurement while avoiding structures other than a cable 77. In this way, when the shape of the measurement range 60 is changed according to the situation of the measurement area, it is possible to measure the ground-based height of the cable with less erroneous detection.

### Example 4

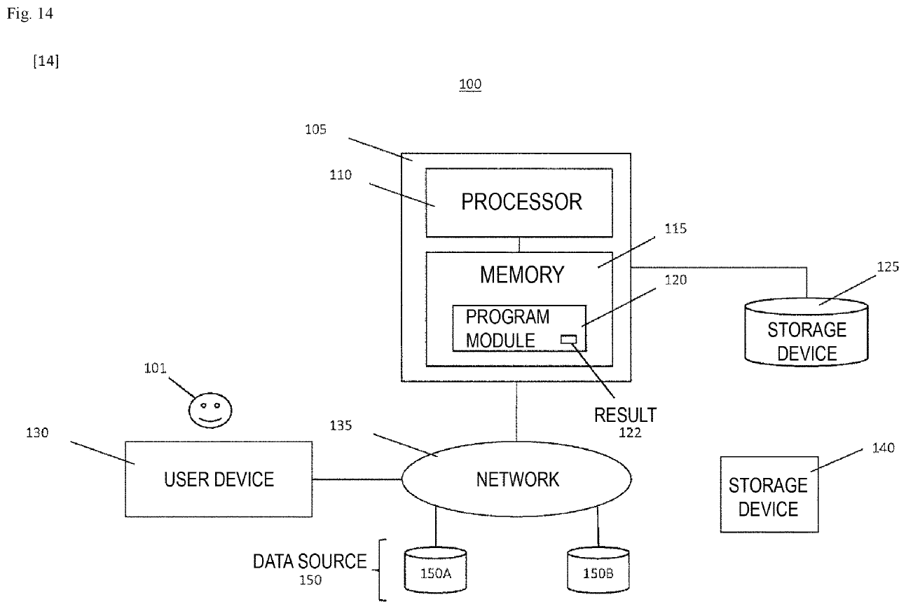

The ground-based height measurement device 301 can also be provided by a computer and a program and the program can be recorded on a recoding medium or provided via a network. FIG. 14 illustrates a block diagram of a system 100. The system 100 includes a computer 105 connected to a network 135.

The network 135 is a data communication network. The network 135 may be a private network or a public network and include any or all of (a) a personal area network covering, for example, a room, (b) a local area network covering, for example, a building, (c) a campus area network covering, for example, a campus, (d) a metropolitan area network covering, for example, a city, (e) a wide area network covering, for example, areas connected across urban, rural, or national boundaries, or (f) an internet. The communication is performed by electronic signals and optical signals via the network 135.

The computer 105 includes a processor 110 and a memory 115 connected to the processor 110. Although the computer 105 is illustrated as a stand-alone device in the present specification, the present disclosure is not limited thereto and the computer may be connected to other devices not illustrated in the distributed processing system.

The processor 110 is an electronic device including logic circuits that respond to and execute commands.

The memory 115 is a storage medium readable to a tangible computer with a computer program encoded therein. In this regard, the memory 115 stores data and commands, that is, program code readable and executable by the processor 110 to control the operation of the processor 110. The memory 115 can be constituted by a random access memory (RAM), a hard drive, a read-only memory (ROM), or a combination thereof. One of components of the memory 115 is a program module 120.

The program module 120 includes commands for controlling the processor 110 to perform the processes described in the present specification. Although the operations are described as being performed by the computer 105, the method, the process, or the subordinate process thereof in the present specification, these operations are actually performed by the processor 110.

In the present specification, the term “module” is used to refer to a functional operation that can be embodied as either a stand-alone component or an integrated configuration of a plurality of lower components. Therefore, the program module 120 may be provided as a single module or as a plurality of modules operated in cooperation with each other. In the present specification, the program module 120 is described as being installed in the memory 115 and provided by software, but can be provided by any of hardware (for example, electronic circuit), firmware, software, or a combination thereof.

The program module 120 is illustrated as already being loaded into the memory 115, but may be configured to be located on a storage device 140 so as to be later loaded into the memory 115. The storage device 140 is a storage medium readable to a tangible computer storing the program module 120. Examples of the storage device 140 include a compact disc, a magnetic tape, a read-only memory, an optical storage medium, a memory unit composed of a hard drive or a plurality of parallel hard drives, and a universal serial bus (USB) flash drive. Alternatively, the storage device 140 may be a random access memory or other types of electronic storage device located in a remote storage system (not illustrated) and connected to the computer 105 via the network 135.

In the present specification, the system 100 further includes a data source 150A and a data source 150B collectively referred to as a data source 150 herein and communicatively connected to the network 135. In fact, the data source 150 can include as many data sources as required, that is, one or more data sources. The data source 150 can include unstructured data and social media.

The system 100 further includes a user device 130 which is operated by a user 101 and is connected to the computer 105 via the network 135. Examples of the user device 130 include input devices such as keyboards or voice recognition subsystems that enable the user 101 to transmit information and command selections to the processor 110. The user device 130 further includes a display device or an output device such as a printer or a voice synthesizer. A cursor control unit such as a mouse, a trackball, or a touch-sensitive screen enables the user 101 to operate a cursor on a display device in order to transmit new information and command selection to the processor 110.

The processor 110 outputs an execution result 122 of the program module 120 to the user device 130. Alternatively, the processor 110 can deliver the output to, for example, a database or a storage device 125 such as a memory or can deliver the output to a remote device (not illustrated) via the network 135.

For example, the program for performing the flowchart of FIG. 6 may be the program module 120. The system 100 can be operated as the ground-based height measurement device 301.

The terms “includes” or “including” specify that features, integrated bodies, steps, or components described therein are present, but should be interpreted that they do not exclude the presence of one or more other features, integrated bodies, steps, or components or groups thereof. The terms “a” and “an” are indefinite articles and therefore do not exclude embodiments having a plurality thereof.

### Other Embodiments

Note that the present disclosure is not limited to the above-described embodiments and can be modified into various forms within the scope not departing from the gist of the present disclosure. In short, the present disclosure is not limited to the embodiments as they are and can be embodied, at the implementation stage, with the components modified within the scope not departing from the gist thereof. For example, in the examples described above, the object to be measured is described as a communication or electrical cable, but the object to be measured is not limited thereto. The object to be measured may be a street tree or building and the height may be measured by the ground-based height measurement device.

Various inventions can be formed by appropriate combinations of a plurality of components disclosed in the above-described embodiments. For example, several components may be deleted from all of the components illustrated in the embodiments. Furthermore, components of different embodiments may be appropriately combined with each other.

### REFERENCE SIGNS LIST

11: Trajectory acquiring unit
12: Parameter specifying unit
13: Measurement range forming unit
14: Point cloud coordinate acquiring unit
15: Count unit
16: Calculation unit
17: Display unit
21: Travel trajectory information
22: Laser point cloud data
23: Map data
31: Three-dimensional point cloud data
50: Travel trajectory
60, 60-1, . . . , 60-N: Measurement ranges
70: Vehicle
71: IMU
72: GPS
73: House
74: Fence
75: Utility pole
76: Road sign
77: Cable
100: System
101: User
105: Computer
110: Processor
115: Memory
120: Program module
122: Result
125: Storage device
130: User device
135: Network
140: Storage device
150: Data source
301: Ground-based height measurement device

1. A ground-based height measurement method comprising:
acquiring a travel trajectory of a vehicle equipped with a mobile mapping system (MMS);
forming a measurement range located at a relative position set in advance with respect to the travel trajectory;
counting the number of three-dimensional point cloud data included in the measurement range and measured by the MMS, and
calculating a ground-based height of an object of the three-dimensional point cloud data from the three-dimensional point cloud data when the number of three-dimensional point cloud data is equal to or smaller than a threshold value.

2. The ground-based height measurement method according to claim 1,
wherein the ground-based height is calculated using a coordinate of a point having the lowest altitude in the three-dimensional point cloud data.

3. The ground-based height measurement method according to claim 1,
wherein the ground-based height is calculated using an average altitude of all points of the three-dimensional point cloud data.

4. The ground-based height measurement method according to claim 1,
wherein the measurement range has a rectangular parallelepiped shape and is located above the travel trajectory.

5. The ground-based height measurement method according to claim 1,
wherein the measurement range has a pyramid or cone shape having a higher altitude as a bottom surface and is located above the travel trajectory.

6. The ground-based height measurement method according to claim 1,
wherein the threshold value is 500 to 1000.

7. A ground-based height measurement device comprising:
a trajectory acquiring unit configured to acquire a travel trajectory of a vehicle equipped with a mobile mapping system (MMS);
a measurement range forming unit configured to form a measurement range located at a relative position set in advance with respect to the travel trajectory;
a count unit configured to count the number of three-dimensional point cloud data included in the measurement range and measured by the MMS; and
a calculation unit configured to calculate a ground-based height of an object of the three-dimensional point cloud data from the three-dimensional point cloud data when the number of three-dimensional point cloud data is equal to or smaller than a threshold value.

8. A non-transitory computer-readable medium having computer-executable instructions that, upon execution of the instructions by a processor of a computer, cause the computer to function as the ground-based height measurement method according to claim 1.
